(19) United States
(12) Patent Application Publication
(10) Pub. No.: US 2016/0214152 A1
(43) Pub. Date: Jul. 28, 2016

(54) SUPERHYDROPHOBIC SURFACE ARRANGEMENT, ARTICLE COMPRISING SAME, AND METHOD OF MANUFACTURE THEREOF

(71) Applicant: City University of Hong Kong, Kowloon Tong (HK)

(72) Inventors: Zuankai WANG, Hong Kong (HK); Yahua Liu, Hong Kong (HK)

(73) Assignee: CITY UNIVERSITY OF HONG KONG, Kowloon Tong (HK)

(21) Appl. No.: 14/606,105

(22) Filed: Jan. 27, 2015

(51) Int. Cl. B08B 17/06; C09D 5/00; C23F 1/34

(52) U.S. Cl. CPC B08B 17/06; C23F 1/34; C09D 5/00

(57) ABSTRACT

The present invention is concerned with a superhydrophobic arrangement. The arrangement has an array of posts residing on a surface, the posts having an elongate configuration with a base portion and an upper portion. The posts have a height from 0.3 to 2 mm, a center to center distance of two adjacent the posts is from 0.1 to 0.4 mm, and surface of the posts is coated with hydrophobic nanoflowers.

### FIELD OF THE INVENTION

The present invention is concerned with a superhydrophobic surface arrangement, an article comprising such arrangement, and a method of manufacture of thereof.

### BACKGROUND OF THE INVENTION

Engineering surfaces that promote rapid detachment of liquid drops is of importance to a wide range of applications including anti-icing, drop-wise condensation, and self-cleaning. The prior art has proposed superhydrophobic surface arrangements which may be able to allow some degree of drop detachment although they are not satisfactory.

The present invention seeks to provide a superhydrophobic surface arrangement with significantly improved drop detachment capability, or at least to provide an alternative to the public.

### SUMMARY OF THE INVENTION

According to a first aspect of the present invention, there is provided a superhydrophobic surface arrangement comprising an array of posts residing on a surface, the posts having an elongate configuration with a base portion and an upper portion, wherein the posts have a height from 0.3 to 2 mm, a center to center distance of two adjacent the posts is from 0.1 to 0.4 mm, and surface of the posts is coated with hydrophobic nanoflowers.

Preferably, in the arrangement the base portion may have a diameter or width from 0.05 to 0.2 mm, and the upper portion may have a diameter or width of 0.2 mm or less. The posts generally may assume a conical configuration or a pyramidal configuration.

In an embodiment, the posts generally may assume a square pyramid configuration. Alternatively, the posts may be truncated and may thus be configured with a substantially flat top.

In one embodiment, the posts may have a tapered configuration with a proximal end being the base portion and a distal end being the upper portion.

In another embodiment, the posts generally may assume a configuration of rectangular or square column or prism.

Advantageously, the surface may be uniformly coated with said hydrophobic nanoflowers. The nanoflowers may have a two-tier structure. In specific embodiments, the diameter of the nanoflowers may range from 2 um to 10 um although in one preferred embodiment, the nanoflowers may have an average diameter of 3.0 um. Each nanoflower may consist of many nanopetals. The nanopetals may be featured with a width in the magnitude or region of dozens of nanometers and a length in the magnitude or region of several micrometers.

In one preferred embodiment, the posts may be made of copper.

According to a second aspect of the present invention, there is provided a substrate comprising a superhydrophobic arrangement as described above.

According to a third aspect of the present invention, there is provided a method of manufacture a substrate as described above, comprising steps of forming the posts by wire cutting and cyclic chemical etching.

According to a fourth aspect of the present invention, there is provided a method of manufacture of a superhydrophobic arrangement on a surface of a substrate, comprising steps of forming an array of posts residing on the surface by wire cutting and cyclic chemical etching, and coating surface of the posts with hydrophobic nanoflowers, wherein the posts have an elongate configuration with a base portion and an upper portion, the posts have a height from 0.3 to 2 mm, and a center to center distance of two adjacent posts is from 0.1 to 0.4 mm.

Preferably, the posts may be formed from cooper or copper plate.

In an embodiment, the base portion may have a diameter or width from 0.05 to 0.2 mm, and the upper portion may have a diameter or width of 0.2 mm or less. The posts generally may assume a conical configuration, a pyramidal configuration or a square pyramid configuration.

In one embodiment, the posts may be truncated and thus may be configured with a substantially flat top.

In another embodiment, the posts may have a tapered configuration with a proximal end being the base portion and a distal end being the upper portion.

In yet another embodiment, the posts generally may assume a rectangular column or a square column.

Suitably, the nanoflowers may have a two-tier structure. The diameter of the nanoflowers may range from 2 um to 10 um.

In a preferred embodiment, the nanoflowers may have an average diameter of 3.0 um.

### BRIEF DESCRIPTION OF THE DRAWINGS

Some embodiments of the present invention will now be explained, with reference to the accompanied drawings, in which:

FIGS. 1A to 1E illustrate an embodiment of surface characterization of a superhydrophobic surface arrangement in accordance with the present invention, and are illustration of drop impact dynamics of the arrangement;

FIGS. 2A to 2B are graphs showing timescale analysis of drop impact on surface arrangement such as the one of FIG. 1A;

FIGS. 3A to 3B are snapshots showing drop impact dynamics on an embodiment of surface arrangement with straight square posts decorated with nanoflowers;

FIG. 3c is a graph showing the variations of t_{↑}, tₘₐₓ, t_{contact} (left y axis) and Q (right y axis) with We;

FIG. 4 is a graph showing the variation of the timescale ratio k=t_{↑}/tₘₐₓ with \sqrt{We}; and

FIGS. 5A to 5C are schematic diagrams showing three different embodiments of surface arrangements in accordance with the present invention.

### DETAILED DESCRIPTION OF PREFERRED EMBODIMENTS OF THE INVENTION

The present invention is concerned with a superhydrophobic arrangement such as a superhydrophobic surface patterned with lattices of submillimetre-scale posts. The posts may be decorated with nano-textures. The use of such posts and/or nanotextures generate a counter-intuitive bouncing regime. For example, liquid drops in contact with the surface tend to spread on impact and then leave the surface in flattended, pancake shape without retracting. The present invention allows for a substantially four-fold reduction in contact time compared to conventional complete rebound. Studies leading to the present invention show that with such arrangement the pancake bouncing results from the rectification of capillary energy stored in the penetrated liquid into upward motion adequate to lift the drop. The present invention is characterized in the provision of surface configurations with tapered micro- and/or nano-textures which behave as harmonic springs. With such configurations, the timescales become independent of the impact velocity, allowing the occurrence of pancake bouncing and rapid drop detachment over a wide range of impact velocities.

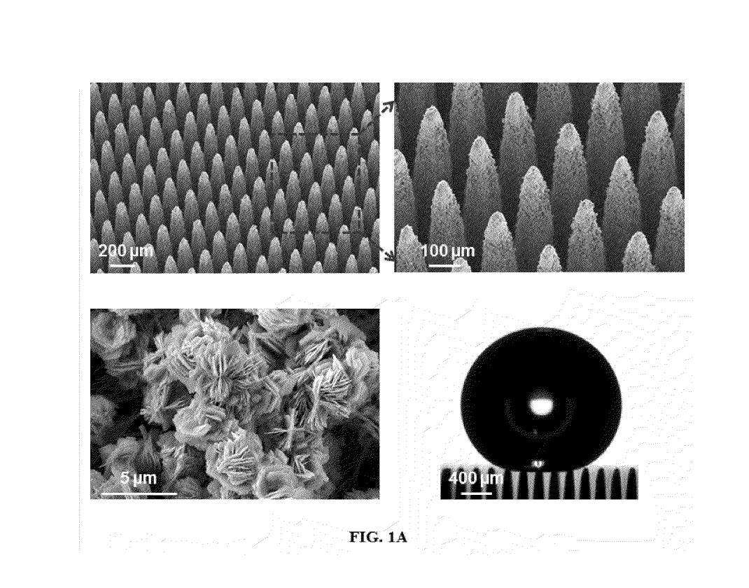

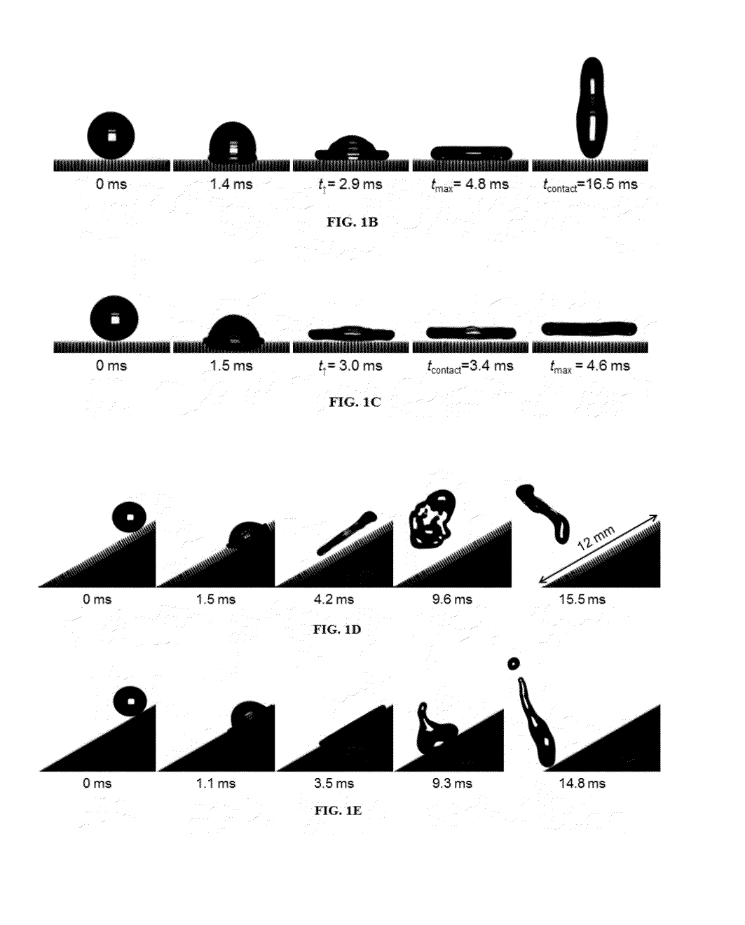

In one embodiment of the present invention, there is provided a copper surface arrangement patterned with a square lattice of tapered posts decorated with nanostructures. Please see FIG. 1 and in particular FIG. 1A. FIG. 1A illustrates scanning electronic micrograph image of the copper surface patterned with a square lattice of tapered posts. The posts have a circular cross section whose diameter increases continuously and linearly from 20 μm to 90 μm with depth. The center-to-center spacing and the height of the posts are substantially 200 μm and 800 μm, respectively. The posts are covered by nanoflowers of with an average diameter of substantially 3.0 μm, exhibiting a contact angle of over 165° and contact angle hysteresis less than 2°. FIG. 1B shows selected snapshots captured by the high speed camera showing a drop (r₀=1.45 mm) impacting on the tapered surface at We=7.1. On touching the surface at t=0, part of the drop penetrates into the post arrays and recoils back (driven by capillary force) to the top of the surface at t_{↑}˜2.9 ms. Here, t_{↑} is the time interval between the moments when the drop first touches the surface and when the substrate is completely emptied, during which fluid undergoes the downward penetration and upward capillary emptying processes. After reaching a maximum lateral extension at tₘₐₓ˜4.8 ms, the drop retracts on the surface and finally detaches from the surface at t_{contact} (˜16.5 ms). FIG. 1C show selected snapshots showing a drop impacting on the tapered surface at We=14.1. The drop bounces off the surface in a pancake shape at ˜3.4 ms. FIGS. 1D and 1E shows selected snapshots showing a drop impinging on the tapered surface and superhydrophobic surface with nanoflower structure alone, respectively, under a tilt angle of 30° at We=31.2. The drop in FIG. 1D impinging on the tapered surface exhibits a pancake bouncing, while the drop in FIG. 1E on the nanostructured surface follows a conventional bouncing pathway. The contact time in the case of pancake bouncing is 3.6 ms, which is four-fold shorter than that on the nanostructured superhydrophobic surface. The lower end or the base of the posts have a wider diameter or width, while towards the upper or distal end the posts have a diameter or width are narrowing. Studies have shown that in workable dimensions, the posts may have a height from 0.3-2 mm and centre-to-centre distance of two adjacent posts from 0.1-0.4 mm.

The post surface is fabricated using a wire cutting machine followed by chemical etching to generate nanoflowers with an average diameter 3.0 μm. After a thin polymer coating, trichloro(1H,1H,2H,2H-peruorooctyl)silane, is applied, the surface exhibits a superhydrophobic property with an apparent contact angle of over 165°. The advancing and receding contact angles are 167.2±1.1° and 163.9±1.4°, respectively. Water drop impact experiments were conducted using a high speed camera at the rate of 10,000 frames per second. The unperturbed radius of the drop is r₀=1.45 mm or 1.10 mm, and the impact velocity (v₀) ranges from 0.59 ms⁻¹ to 1.72 ms⁻¹, corresponding to 7.1<We<58.5, where We=pv₀²r₀/γ is the Weber number, with ρ the density and γ being the surface tension of water.

FIG. 1B shows selected snapshots of a drop impinging on such a surface at We=7.1. On touching the surface at t=0, part of the drop penetrates into the post arrays in a localized region with the radius approximately equivalent to the initial drop radius and recoils back, driven by the capillary force, to the top of the surface at 2.9 ms. After reaching a maximum lateral extensionl9 at 4.8 ms, the drop retracts on the surface and finally detaches from the surface at 16.5 ms (=2.55\sqrt{ρr₀³/γ}). This contact time is in good agreement with previous results for conventional complete rebound. However, at higher We, the drop exhibits a distinctively different bouncing behaviour, which is referred as pancake bouncing, as exemplified by an impact at We=14.1. Please see FIG. 1C. In this case, the liquid penetration is deeper and the drop detaches from the surface (at 3.4 ms=0.53\sqrt{ρr₀³/γ}) immediately after the capillary emptying without experiencing retraction.

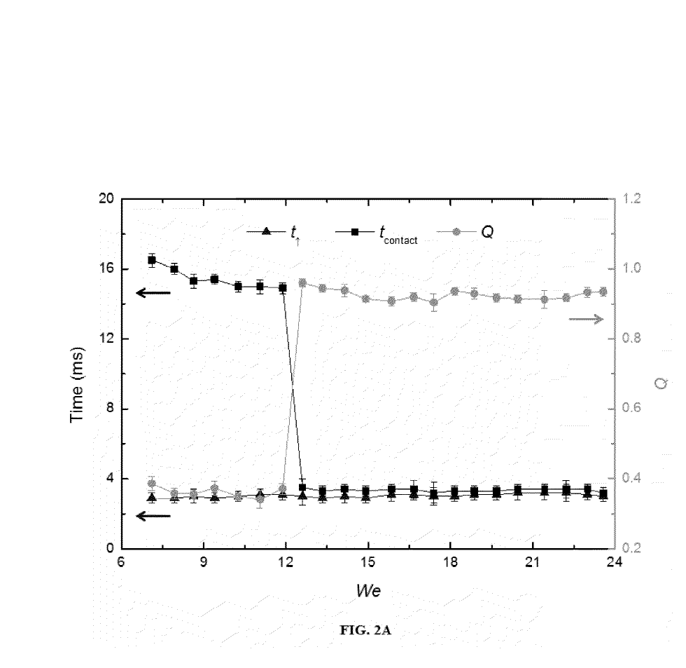

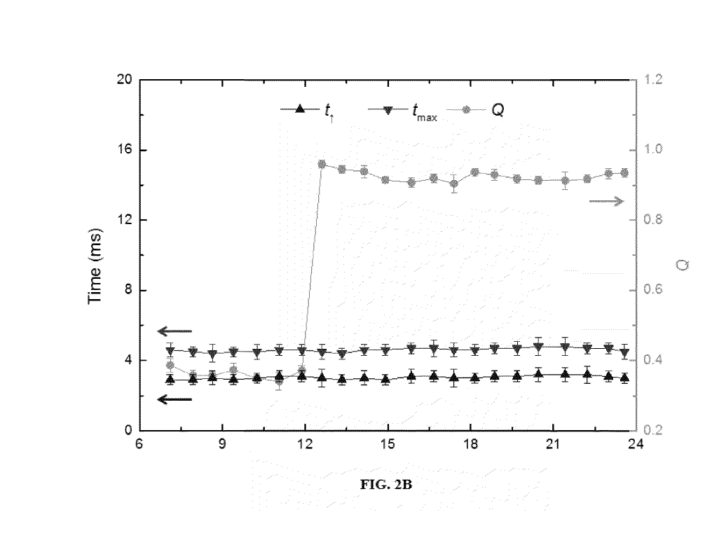

The difference in bouncing dynamics between conventional rebound and pancake bouncing can be quantified by the ratio of the diameter of the drop when it detaches from the surface dⱼᵤₘₚ to the maximum spreading width of the drop dₘₐₓ. The ratio Q=dⱼᵤₘₚ/dₘₐₓ is defined as the pancake quality, with Q>0.8 referred to as pancake bouncing. At low Weber number (We<12.6), the pancake quality Q is ˜0.4, corresponding to conventional bouncing. Please see FIG. 2 and in particular FIG. 2A. FIG. 2A shows the variations of t_{↑}, t_{contact} (left y axis), and pancake quality Q (=dⱼᵤₘₚ=dₘₐₓ, right y axis) with We for drop radius r₀=1.45 mm. At low We<12, the drop exhibits conventional bouncing with t_{contact} much larger than t_{↑}. However, at high We>12 the drop bounces as a pancake with t˜t_{contact}. FIG. 2B shows the variations of t_{↑}, tₘₐₓ (left y axis) and Q (right y axis) with We. t_{↑} and tₘₐₓ are nearly constant over a wide range of We from 8 to 24. Each data point is the average of three measurements. Error bars denote the range of the measurements.

However, for We>12.6 there is a clear crossover to Q˜1, which corresponds to pancake bouncing. Moreover, a defining feature of pancake bouncing, of particular relevance to applications aimed at rapid drop shedding, is the short contact time of the drop with the solid surface. In the case of pancake bouncing, the contact time, t_{contact}, is reduced by a factor of over four to 3.4 ms as compared to conventional rebound.

Drop impact experiments were also performed on tilted surfaces which is more relevant geometrically to practical applications, such as self-cleaning, de-icing and thermal management. FIG. 1D shows selected snapshots of a drop impinging on the tapered surface with a tilt angle of 30° at We=31.2. The drop impinging on the tilted tapered surface also exhibits pancake bouncing. Moreover, the drop completely detaches from the surface within 3.6 ms and leaves the field of view without bouncing again. Comparison was also made on the drop impact on the tilted surface with nanoflower structure alone. The apparent contact angle of the nanostructured surface is 160±1.8°. It is evident that a drop impinging on such a surface follows a conventional bouncing pathway: the drop spreads to a maximum diameter, recoils back, and finally leaves the surface within 14.5 ms. Please see FIG. 1E.

These results indicate that the pancake bouncing of a drop occurring close to its maximum lateral extension results from the rectification of the capillary energy stored in the penetrated liquid into upward motion adequate to lift the entire drop. Moreover, for the drop to leave the surface in a pancake shape, the timescale for the vertical motion between posts should be comparable to that for the lateral spreading. In order to illustrate that pancake bouncing is driven by the upward motion rendered by the capillary emptying, comparison was made between the two timescales t_{contact} and t_{↑}, where t_{↑} is the time interval between the moment when the drop first touches the surface and when the substrate is completely emptied, during which fluid undergoes the downward penetration and upward capillary emptying processes. As shown in FIG. 2A, in the regime of pancake bouncing, t_{contact} and t_{↑} are close, indicating that the pancake bouncing is driven by the upward motion of the penetrated liquid. For smaller We (<12.6), the two time scales diverge: t_{↑} remains approximately constant while t_{contact} increases sharply. This is because, at low We, the penetrated liquid does not have the kinetic energy sufficient to lift the drop at the end of the capillary emptying. Accordingly, the drop continues to spread and retract in contact with the surface before undergoing conventional bouncing. Variations of t_{↑}, tₘₐₓ, and Q with We were plotted, where tₘₐₓ is the time when the drop reaches its maximum lateral extension. Please see FIG. 2A. On tapered surfaces, t_{↑} and tₘₐₓ are comparable with each other for all the We measured. However, at low We (<12.6), there is no pancake bouncing due to insufficient energy to lift the drop, further indicating that the occurrence of pancake bouncing necessitates the simultaneous satisfaction of sufficient impact energy and comparable timescales.

Comparison was made on the experimental results for bouncing on straight square posts covered by nanoflower structures. The post height and edge length (b) are 1.2 mm and 100 μm, respectively. It was observed that the pancake bouncing behavior is sensitive to post spacing and We. Pancake bouncing is absent on post arrays with w=200 μm, whereas it occurs for surfaces with w=300 μm and 400 μm.

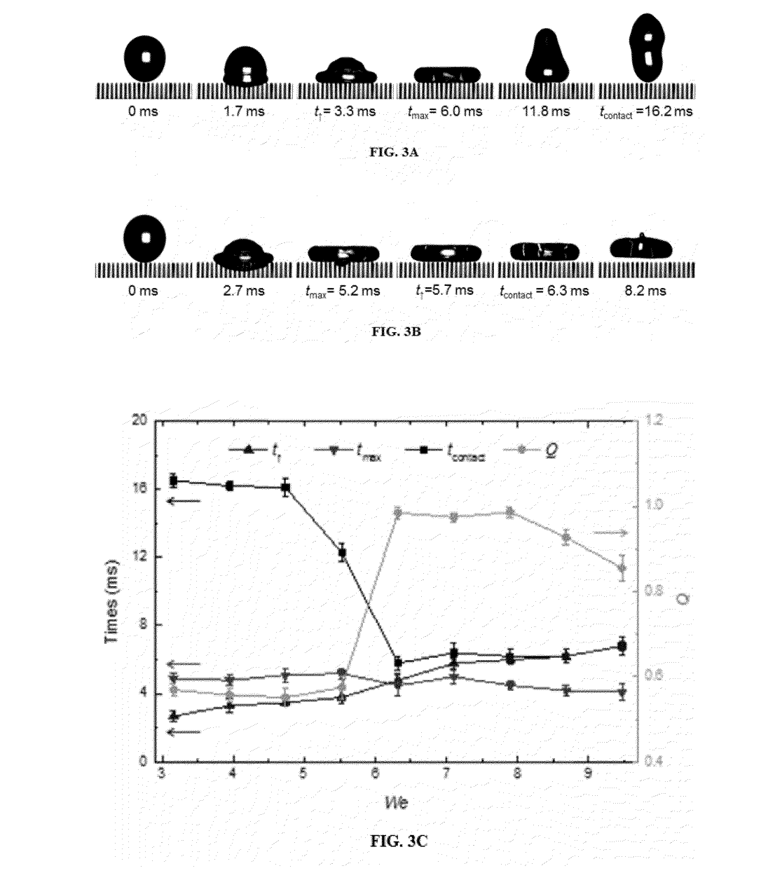

FIG. 3A shows selected snapshots of a drop impinging on straight posts decorated with nanoflowers with a post centre-to-centre spacing of 300 μm at We=4.7. The drop exhibits conventional rebound with pancake quality Q˜0.59. tₘₐₓ˜6.0 ms is much larger than t_{↑}˜3.3 ms. FIG. 3B shows selected snapshots of a drop impinging on post arrays with a post centre-to-centre spacing of 300 μm at We=7.9. Pancake bouncing is observed with pancake quality Q˜0.98, tₘₐₓ˜5.2 ms is slightly less than t_{↑}˜5.7 ms.

FIGS. 3A and 3B compare results for the bouncing of a drop (r₀˜1.45 mm) on the surface with spacing 300 μm at We=4.7 and 7.9, respectively. In the former case, the drop exhibits a conventional complete rebound, with Q˜0.59 and t_{contact}˜16.2 ms. In the latter case, the drop shows pancake bouncing with Q˜0.98 and a much reduced contact time t_{contact} 6.3 ms. FIG. 3C shows the variations of t_{↑}, tₘₐₓ, t_{contact}, and Q with We for this surface. In the region of pancake bouncing (6.3≦We≦9.5), the proximity of t_{contact} and t_{↑} and the matching between tₘₐₓ and t_{↑} are consistent with the observations on tapered surfaces. By contrast, in the non-pancake bouncing region (We≦6.3), there is a large divergence between t_{contact} and t_{↑}, because We is too small to allow drop bouncing as a pancake. This further confirms that the occurrence of pancake bouncing necessitates simultaneous satisfaction of the two criteria. In contrast to what is observed for tapered surfaces, a dependence of t_{↑} on We is noted to appear on straight posts. Moreover, it is shown that the maximum jumping height of drops in a pancake shape on straight posts is three-fold smaller than that on tapered surfaces (2.88 mm and 0.9 mm, respectively) and that the contact time (˜6.3 ms) on straight posts is larger than that (˜3.4 ms) on tapered surfaces. All these characteristics and behaviors reveal that the pancake bouncing on tapered surfaces is more pronounced and robust than that on straight posts. However, at high We>6.3, the drop bounces in the shape of a pancake with t_{↑}˜t_{contact}. Unlike on the tapered surfaces, t_{↑} increases with increasing We. Each data point is the average of three measurements. Error bars denote the range of the measurements.

Analysis was conducted to elucidate the enhanced pancake bouncing observed on tapered posts in comparison to straight posts. The timescale tₘₐₓ scales as \sqrt{ρr₀³/γ}, independent of the impact velocity. To calculate t_{↑}, the kinetics involved in the processes of liquid penetration and capillary emptying was considered. Here, the viscous dissipation was neglected since the Reynolds number in the impact process is 100. The liquid penetrating into the space between posts is subject to a capillary force, which serves to halt and then reverse the flow. The capillary force can be approximated by bnγ cos θ_{Y}, where n is the number of posts wetted, and θ_{Y} is the intrinsic contact angle of the nanoflower-covered posts. The deceleration (acceleration) of the penetrated liquid moving between the posts scales as a_{↑}˜bγ cos θ_{Y}/(ρr₀w²), where the drop mass ˜pr₀³, n˜r₀²/w², and it is considered that the liquid does not touch the base of the surface. It is to be noted that the number of posts wetted is independent of We because the penetrating liquid is mainly localized in a region with a lateral extension approximatively equivalent to the initial drop diameter, rather than the maximum spreading diameter. For straight posts, the acceleration is constant. Thus, t_{↑}˜v₀/a_{↑}˜v₀ρr₀w²/(−bγ cos θ_{Y}), and the ratio of the two timescales can be expressed as

$$k = {t}_{↑} / {t}_{max} \sim \sqrt{We} \frac{{w}^{2}}{( - {br}_{0} cos {θ}_{Y} )} \qquad ( 1 )$$

which scales as \sqrt{We}. These experiments show, and as discussed previously, that the occurrence of pancake bouncing requires t_{↑} and tₘₐₓ to be comparable, i.e., k˜1. The dependence of k on We indicates that this condition can be satisfied only over a limited range of We.

Unexpectedly, k and We become decoupled by designing surfaces with tapered posts. Since the post diameter b now increases linearly with the depth z below the surface (that is, b˜βz, where β is a structural parameter), the acceleration of the penetrated liquid moving between posts is linearly proportional to penetration depth (i.e., a_{↑}∝z). As a result, the surface with tapered posts acts as a harmonic spring with t_{↑}˜\sqrt{w²r₀ρ/(−βγ cos θ_{Y})}. Therefore, the ratio becomes

$$k \sim \frac{w}{{r}_{0} \sqrt{- β cos {θ}_{Y}}} \qquad ( 2 )$$

which is independent of We.

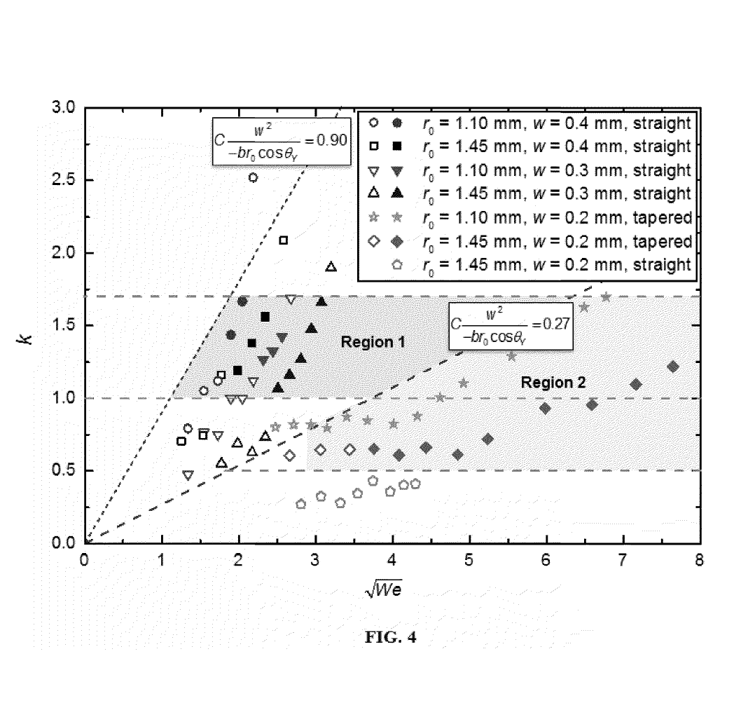

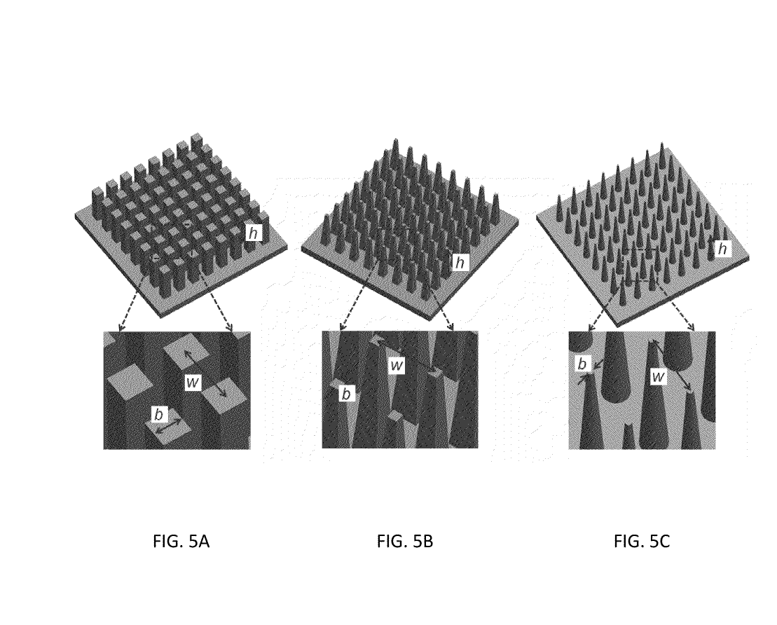

To pin down and demonstrate the key surface features and drop parameters for the occurrence of pancake bouncing, we plotted the variation of k with \sqrt{We} in the design diagram. Please see FIG. 4. FIG. 4 shows the variation of the timescale ratio k=t_{↑}/tₘₐₓ with \sqrt{We}, showing different pancake bouncing regions. Full symbols denote that the drop jumps as a pancake. Region 1 corresponds to the pancake bouncing on straight posts with 1.0<k<1.7 and We in a restricted range. The two slanting lines, corresponds to −w²/(br₀ cos θ_{Y})=0.45 and 1.5 (based on equation (1), with a fitting prefactor C=0.6). Region 2 corresponds to pancake bouncing on tapered surfaces over a much wider range of k from 0.5 to 1.7 and We from 8.0 to 58.5. It is to be noted that k is independent of We over a wide range. It becomes weakly dependent on We for higher impact velocities due to the penetrated liquid hitting the base of the surface.

Filled symbols represent pancake bouncing (defined by Q>0.8) and open symbols denote conventional bouncing. Region 1 corresponds to the pancake bouncing occurring on straight posts with 1.0<k<1.7. The data show that k˜\sqrt{We} as predicted by equation (1) above. Such a dependence of k on We explains the limited range of We for which such rebound is observed in the experiments. The two slanting lines bounding Region 1 for pancake bouncing on straight posts correspond to w²/(−br₀ cos θ_{Y})=0.45 and 1.5 in equation (1). For almost all the reported, this parameter takes values between 0.01 and 0.144, smaller than the threshold demonstrated in the studies leading to the present invention by at least one order of magnitude. On such surfaces, either the liquid penetration is insignificant (for example, owing to too narrow and/or too short posts) or the capillary energy stored cannot be rectified into upward motion adequate to lift the drop (for example, owing to an unwanted Cassie-to-Wenzel transition). Region 2 shows that the introduction of tapered posts significantly widens the range of timescale and Weber number for pancake bouncing, way beyond Region 1. In this Region, the pancake bouncing can occur over a wider range of k from 0.5 to 1.7 and We from 8.0 to 58.5. As illustrated above, for small We with moderate liquid penetration, the two timescales tₘₐₓ and t_{↑} are independent of We. They become weakly dependent on We for relative large We due to the penetrated liquid hitting the base of the surface, but the emergence of pancake bouncing is rather insensitive to the post height as long as this is sufficient to allow for adequate capillary energy storage. For much shorter posts, for example the tapered surface with a post height of 0.3 mm, there was no observation of pancake bouncing due to insufficient energy storage.

The novel pancake bouncing is also observed on a multi-layered, two-tier, superhydrophobic porous (MTS) surface. The top layer of the MTS surface consists of a post array with post centre-to-centre spacing of ˜260 μm and the underlying layers comprise a porous medium of pore size 200 μm, naturally forming a graded pathway for drop penetration and capillary emptying. The typical contact time of the drop with the MTS surface is t_{contact}˜5.0 ms and the range of We is between 12 and 35 for pancake bouncing. These values are comparable to those on tapered surfaces. Taken together, it is shown that tapered post surfaces and MTS surfaces of the present invention demonstrate the counter-intuitive pancake bouncing and is a general and robust phenomenon. Moreover, there is enormous scope for designing structures to optimize pancake bouncing for multifunctional applications.

Methods

Preparation of Tapered Surface and Straight Post Arrays

The tapered surface with a size of 2.0×2.0 cm² was created based on type 101 copper plate with a thickness of 3.18 mm by combining a wire-cutting method and multiple chemical etching cycles. Square posts in the configuration of square prisms arranged in a square lattice were first cut with a post centre-to-centre spacing of 200 μm. The post edge length and height are 100 μm and 800 μm, respectively. Then the as-fabricated surface was ultrasonically cleaned in ethanol and deionized water for 10 min, respectively, followed by washing with diluted hydrochloric acid (1 M) for 10 s to remove the native oxide layer. To achieve a tapered surface with post diameter of 20 μm at the top, six cycles of etching were conducted. In each cycle, the as-fabricated surface was first immersed in a freshly mixed aqueous solution of 2.5 moll⁻¹ sodium hydroxide and 0.1 ml⁻¹ ammonium persulphate at room temperature for ˜60 mins, followed by thorough rinsing with deionized water and drying in nitrogen stream. As a result of chemical etching, CuO nanoflowers with an average diameter ˜3.0 μm were produced. Note that the etching rate at the top of the posts is roughly eight-fold of that at the bottom of the surface due to the formation of an etchant solution concentration gradient generated by the restricted spacing between the posts. To facilitate further etching, after each etching cycle the newly-etched surface was washed by diluted hydrochloric acid (1 M) for 10 s to remove the oxide layer formed during the former etching cycle. Then another etching cycle was performed to sharpen the posts. In preparing the straight post arrays, only one etching cycle was conducted. All the surfaces were modified by silanzation through immersion in 1 mM n-hexane solution of trichloro(1H,1H,2H,2H-peruorooctyl)silane for ˜60 mins, followed by heat treatment at ˜150° C. in air for 1 hour to render surfaces superhydrophobic.

Preparation of MTS Surface

The MTS surface is fabricated on a copper foam with density 0.45 gcm⁻³, porosity 94%, and thickness 0.16 cm. The nanostructure formation on the MTS surface and silanization were conducted using the same procedures described above.

Contact Angle Measurements

The static contact angle on the as-prepared substrate was measured from sessile water drops with a ramé-hart M200 Standard Contact Angle Goniometer. Deionized water drops of 4.2 μl, at room temperature with 60% relative humidity, were deposited at a volume rate of 0.5 μl s⁻¹. The apparent, advancing (θₐ) and receding contact angles (θᵣ) on the tapered surface with centre-to-centre spacing of 200 μm are 165.6±1.3°, 167.2°±1.1° and 163.9°±1.4°, respectively. The apparent (equivalent to the intrinsic contact angle on a tapered surface), advancing (θₐ) and receding contact angle (θᵣ) on the surface with nanoflower structure alone are 160°±1.8°, 162.4°±2.8°, and 158.8°±1.7°, respectively. At least five individual measurements were performed on each substrate.

Impact Experiments

The whole experimental setup was placed in ambient environment, at room temperature with 60% relative humidity. Water drops of −13 μl and 6 μl (corresponding to radii ˜1.45 mm and 1.10 mm, respectively) were generated from a fine needle equipped with a syringe pump (KD Scientific Inc.) from pre-determined heights. The dynamics of drop impact was recorded by a high speed camera (Fastcam SA4, Photron limited) at the frame rate of 10,000 fps with a shutter speed 1/93,000 sec, and the deformation of drops during impingement were recorded using Image J software (Version 1.46, National Institutes of Health, Bethesda, Md.).

It should be understood that certain features of the invention, which are, for clarity, described in the content of separate embodiments, may be provided in combination in a single embodiment. Conversely, various features of the invention which are, for brevity, described in the content of a single embodiment, may be provided separately or in any appropriate sub-combinations. It is to be noted that certain features of the embodiments are illustrated by way of non-limiting examples. Also, a skilled person in the art will be aware of the prior art which is not explained in the above for brevity purpose. For example, a skilled in the art is aware of the prior art listed below. Contents of this prior art are incorporated herein in their entirety.

### REFERENCES

1. Richard, D., Clanet, C. & Quéré, D. Contact time of a bouncing drop. Nature 417, 811 (2002).
2. Bird, J. C., Dhiman, R., Kwon, H.-M. & Varanasi, K. K. Reducing the contact time of a bouncing drop. Nature 503, 385-388 (2013).
3. Jung, S., Tiwari, M. K., Doan, N. V. & Poulikakos, D. Mechanism of supercooled droplet freezing on surfaces. Nat. Commun. 3, 615 (2012).
4. Mishchenko, L. et al. Design of ice-free nanostructured surfaces based on repulsion of impacting water droplets. ACS Nano 4, 7699-7707 (2010).
5. Stone, H. A. Ice-phobic surfaces that are wet. ACS Nano 6, 6536-6540 (2012).
6. Chen, X. et al. Nanograssed micropyramidal architectures for continuous dropwise condensation. Adv. Funct. Mater. 21, 4617-4623 (2011).
7. Blossey, R. Self-cleaning surfaces-virtual realities. Nat. Mater. 2, 301-306 (2003).
8. Tuteja, A. et al. Designing superoleophobic surfaces. Science 318, 1618-1622 (2007).
9. Deng, X., Mammen, L., Butt, H. J. & Vollmer, D. Candle soot as a template for a transparent robust superamphiphobic coating. Science 335, 67-70 (2012).
10. Okumura, K., Chevy, F., Richard, D., Quéré, D. & Clanet, C. Water spring: A model for bouncing drops. Europhys. Lett. 62, 237 (2003).
11. Reyssat, M., P_epin, A., Marty, F., Chen, Y. & Quéré, D. Bouncing transitions on microtextured materials. Europhys. Lett. 74, 306 (2006).
12. Bartolo, D. et al. Bouncing or sticky droplets: Impalement transitions on superhydrophobic micropatterned surfaces. Europhys. Lett. 74, 299 (2006).
13. McCarthy, M. et al. Biotemplated hierarchical surfaces and the role of dual length scales on the repellency of impacting droplets. Appl. Phys. Lett. 100, 263701 (2012).
14. Moulinet, S. & Bartolo, D. Life and death of a fakir droplet: Impalement transitions on superhydrophobic surfaces. Eur. Phys. J. E. 24, 251-260 (2007).
15. Jung, Y. C. & Bhushan, B. Dynamic effects of bouncing water droplets on superhydrophobic surfaces. Langmuir 24, 6262-6269 (2008).
16. Cha, T. G., Yi, J. W., Moon, M. W., Lee, K. R. & Kim, H. Y. Nanoscale patterning of micro-textured surfaces to control superhydrophobic robustness. Langmuir 26, 8319-8326 (2010).
17. Tran, T. et al. Droplet impact on superheated micro-structured surfaces. Soft Matter 9, 3272{93282 (2013).
18. Chen, X. et al. Synthesis and characterization of superhydrophobic functionalized Cu(OH)₂ nanotube arrays on copper foil. Appl. Surf. Sci. 255, 4015-4019 (2009).
19. Clanet, C., B_eguin, C., Richard, D., Quéré, D. et al. Maximal deformation of an impacting drop. J. Fluid Mech. 517, 199-208 (2004).
20. Vakarelski, I. U., Patankar, N. A., Marston, J. O., Chan, D. Y. C. & Thoroddsen, S. T. Stabilization of leidenfrost vapour layer by textured superhydrophobic surfaces. Nature 489, 274-277 (2012).
21. Lembach, A. N. et al. Drop impact, spreading, splashing, and penetration into electrospun nanofiber mats. Langmuir 26, 9516-9523 (2010).
22. Deng, X., Schellenberger, F., Papadopoulos, P., Vollmer, D. & Butt, H. J. Liquid drops impacting superamphiphobic coatings. Langmuir 29, 7847-7856 (2013).
23. Xu, L., Zhang, W. W. & Nagel, S. R. Drop splashing on a dry smooth surface. Phys. Rev. Lett. 94, 184505 (2005).
24. Wenzel, R. N. Resistance of solid surfaces to wetting by water. Ind. Eng. Chem. 28, 988-994 (1936).
25. Cassie, A. B. D. & Baxter, S. Wettability of porous surfaces. Trans. Faraday Soc. 40, 546-551 (1944).
26. Lafuma, A. & Quéré. Superhydrophobic states. Nat. Mater. 2, 457-460 (2003).
27. Verho, T. et al. Reversible switching between superhydrophobic states on a hierarchically structured surface. Proc. Natl. Acad. Sci. 109, 10210-10213 (2012).
28. Yarin, A. Drop impact dynamics: Splashing, spreading, receding, bouncing. Annu. Rev. Fluid Mech. 38, 159-192 (2006).
29. Quéré, D. Wetting and roughness. Ann. Rev. Mater. Res. 38, 71-99 (2008).
30. Zheng, Y. et al. Directional water collection on wetted spider silk. Nature 463, 640 (2010).

1. A superhydrophobic surface arrangement comprising an array of posts residing on a surface, said posts having an elongate configuration with a base portion at one end and an upper portion at an opposite end, wherein:
said posts have a height from 0.3 to 2 mm;
a center to center distance of two adjacent said posts is from 0.1 to 0.4 mm; and
surface of said posts is coated with hydrophobic nanoflowers.

2. An arrangement as claimed in claim 1, wherein:
said base portion has a diameter or width from 0.05 to 0.2 mm; and
said upper portion has a diameter or width of 0.2 mm or less.

3. An arrangement as claimed in claim 2, wherein said posts generally assume a conical configuration or a pyramidal configuration.

4. An arrangement as claimed in claim 3, wherein said posts generally assume a square pyramid configuration.

5. An arrangement as claimed in claim 3, wherein said posts are truncated and are thus configured with a substantially flat top.

6. An arrangement as claimed in claim 2, wherein said posts have a tapered configuration with a proximal end being said base portion and a distal end being said upper portion.

7. An arrangement as claimed in claim 2, wherein said posts generally assume a configuration of rectangular or square prism.

8. An arrangement as claimed in claim 1, wherein said surface is uniformly coated with said hydrophobic nanoflowers.

9. An arrangement as claimed in claim 1, wherein said nanoflowers have a two-tier structure with a plurality of nanopetals.

10. An arrangement as claimed in claim 8, wherein said nanoflowers have an average diameter of from 2 um to 10 um, or preferably 3.0 um.

11. An arrangement as claimed in claim 1, wherein said posts are made of copper.

12. A substrate comprising a superhydrophobic arrangement as claimed in claim 1.

13. A method of manufacture a substrate as claimed in claim 12, comprising steps of forming said posts by wire cutting and cyclic chemical etching.

14. A method of manufacture of a superhydrophobic arrangement on a surface of a substrate, comprising steps of:
forming an array of posts residing on the surface by wire cutting and cyclic chemical etching; and
coating surface of said posts with hydrophobic nanoflowers;
wherein:
said posts have an elongate configuration with a base portion and an upper portion;
said posts have a height from 0.3 to 2 mm; and
a center to center distance of two adjacent said posts is from 0.1 to 0.4 mm.

15. A method as claimed in claim 14, wherein said posts are formed from cooper or copper wire.

16. A method as claimed in claim 14, wherein:
said base portion has a diameter or width from 0.05 to 0.2 mm; and
said upper portion has a diameter or width of 0.2 mm or less.

17. A method as claimed in claim 16, wherein said posts generally assume a conical configuration, a pyramidal configuration or a square pyramid configuration.

18. A method as claimed in claim 17, wherein said posts are truncated and are thus configured with a substantially flat top.

19. A method as claimed in claim 17, wherein said posts have a tapered configuration with a proximal end being said base portion and a distal end being said upper portion.

20. A method as claimed in claim 16, wherein said posts generally assume a rectangular column or a square column.

21. A method as claimed in claim 14, wherein said nanoflowers have a two-tier structure and with a plurality of nanopetals.

22. An arrangement as claimed in claim 14, wherein said nanoflowers have an average diameter from 2 um to 10 um, or preferably 3.0 um.
